(19) United States
(12) Patent Application Publication
(10) Pub. No.: US 2011/0156885 A1
(43) Pub. Date: Jun. 30, 2011

(54) BIDIRECTIONAL REMOTE CONTROL SYSTEM AND METHOD USING MOBILE INTERFACE DEVICE

(75) Inventors: Seong Hak BAEK, Busan (KR); Byung Nam YUN, Busan (KR); Jae Pyung KO, Yangsan-si (KR); Jae Woo YANG, Busan (KR)

(73) Assignee: Dong-A University Research Foundation For Industry -Academy Cooperation, Busan (KR)

(21) Appl. No.: 12/968,979

(22) Filed: Dec. 15, 2010

(30) Foreign Application Priority Data
Dec. 29, 2009 (KR) 10-2009-0133451
Apr. 16, 2010 (KR) 10-2010-0035081

(51) Int. Cl. G08C 19/16

(52) U.S. Cl. 340/12.5

(57) ABSTRACT

Provided are a bidirectional remote control system and method using a mobile interface device, while allowing a remote control over a control target even when a user and the control target are separated beyond a visible range, allowing an automatic control over the control target within a given distance between a user and the control target, and allowing a user to monitor operating status of the control target. The mobile interface device receives a remote control command from a portable electronic apparatus through a short range wireless communication or creates the remote control command when detecting an approach to the control target within a given distance. Then the mobile interface device sends the remote control command to an electronic control unit (ECU) in the control target through a radio frequency (RF) communication. Also, the mobile interface device receives operating status information about the control target from the ECU and then sends the received information to the portable electronic apparatus.

### BACKGROUND OF THE INVENTION

1. Field of the Invention

The present invention relates in general to a remote control technology and, more particularly, to a bidirectional remote control system and method using a mobile interface device, while allowing a remote control over a control target even when a user and the control target are separated beyond a visible range, allowing an automatic control over the control target within a given distance between a user and the control target, and allowing a user to monitor operating status of the control target.

2. Description of the Related Art

Normally if there is a need of a remote control for a certain target, a user may control the target by using a separate wireless controller that can communicate with a communication module equipped in the target. For instance, if the control target is a car, a user may perform a remote control such as an open and shut of a door or a start-up of an engine by manipulating a wireless controller through a communication module installed in the car.

However, this conventional remote control technique may require that a user should carry the wireless controller for a remote control and always handle the wireless controller within a distance capable of communication with the control target. Also, considering that most users have cellular phones in these days, it may be quite cumbersome for a user to carry and handle the wireless controller for a remote control in addition to the cellular phone.

Recently proposed in view of the above problems is a car remote control system that allows a remote control such as an open and shut of a door or a start-up of an engine by using a cellular phone having a Bluetooth module therein.

Unfortunately, since Bluetooth is designed for a short range (e.g., about 10 meters), this remote control system may fail to control a car when a remote control distance exceeds a given short range.

Additionally, this conventional system may always rely upon a user's manipulation to control the target and also may not allow a user to monitor the result of control, namely, to check operating status of the target.

### BRIEF SUMMARY OF THE INVENTION

Accordingly, the present invention is to address the above-mentioned problems and/or disadvantages and to offer at least the advantages described below.

One aspect of the present invention is to provide a bidirectional remote control system and method using a mobile interface device and allowing a remote control over a control target even when a user and the control target are separated in the far distance beyond a visible range.

Another aspect of the present invention is to provide a bidirectional remote control system and method using a mobile interface device and allowing a user to monitor operating status of the control target even in the far distance beyond a visible range.

Still another aspect of the present invention is to provide a bidirectional remote control system and method using a mobile interface device and allowing an automatic control over the control target within a given distance between a user and the control target by detecting a user's approach to the control target.

According to one aspect of the present invention, provided is a remote control system for a selected control target, the system comprising a portable electronic apparatus, a mobile interface device, and an electronic control unit (ECU). The portable electronic apparatus is configured to create a remote control command for controlling the control target, to send the created command to the mobile interface device through a short range wireless communication, to receive operating status information about the control target depending on the remote control command from the mobile interface device, and to display the received information thereon. The mobile interface device is configured to receive the remote control command from the portable electronic apparatus through the short range wireless communication or to create the remote control command when detecting an approach to the control target within a given distance, to send the remote control command to the ECU in the control target through a radio frequency (RF) communication, to receive the operating status information about the control target from the ECU, and to send the received information to the portable electronic apparatus. The ECU is installed in the control target and is also configured to receive the remote control command from the mobile interface device through the RF communication, to enable the control target to operate in response to the received command, and to send the operating status information about the control target to the mobile interface device.

In the remote control system, the portable electronic apparatus may include an input unit, a short range communication unit, and a control unit. The input unit is configured to receive a user's manipulation and then to create a corresponding input signal. The short range communication unit is configured to perform the short range wireless communication with the mobile interface device. The control unit is configured to create the remote control command for the control target in response to the input signal from the input unit and then to send the created command to the mobile interface device through the short range communication unit.

In the remote control system, the portable electronic apparatus may further include a display unit configured to display the operating status information under the control of the control unit.

In the remote control system, the ECU may include an RF transceiver unit and a control unit. The RF transceiver unit is configured to perform the RF communication with the mobile interface device. The control unit is configured to receive the remote control command from the mobile interface device through the RF transceiver unit, to output a control signal for operation of the control target in response to the received command, and to send the operating status information about the control target to the mobile interface device through the RF transceiver.

In the remote control system, the ECU may further include a low frequency (LF) transmitter unit configured to send an LF signal. In this case, the mobile interface device may be further configured to receive the LF signal from the LF transmitter of the ECU, to determine by using the received LF signal whether the mobile interface device approaches the control target, to create the remote control command for the control target in case of an approach to the control target, and to send the created command to the ECU through the RF communication.

In the remote control system, the control target may include at least one of a car, a motorcycle, a computer, a digital door lock, a TV, and a beam projector.

According to another aspect of the present invention, provided is a mobile interface device which comprises a short range communication unit, a radio frequency (RF) transceiver unit, and a data processing unit. The short range communication unit is configured to perform a short range wireless communication with a portable electronic apparatus. The RF transceiver unit is configured to perform an RF communication with an electronic control unit (ECU) installed in a control target. The data processing unit is configured to create a remote control command for the control target by detecting an approach to the control target within a given distance, to send the remote control command to the ECU through the RF transceiver unit, to receive operating status information about the control target depending on the remote control command from the ECU through the RF transceiver unit, and to send the received information to the portable electronic apparatus through the short range communication unit.

The mobile interface device may further comprise a low frequency (LF) receiver unit configured to receive an LF signal from the ECU. Here, the data processing unit may be further configured to receive the LF signal from the ECU through the LF receiver unit, to calculate a distance between the mobile interface device and the control target, to create the predefined remote control command for the control target if the calculated distance is less than a given value, and to send the created command to the ECU through the RF transceiver unit.

In the mobile interface device, the data processing unit may be further configured to receive the remote control command for the control target from the portable electronic apparatus through the short range communication unit and then to send the received command to the ECU through the RF transceiver unit.

The mobile interface device may further comprise a connection unit configured to be coupled to a connection terminal of the portable electronic apparatus.

In the mobile interface device, the connection unit may receive electric power from the portable electronic apparatus after being coupled to the connection terminal of the portable electronic apparatus.

According to still another aspect of the present invention, provided is a bidirectional remote control method using a mobile interface device, the method comprising a step of sending a remote control command in which a mobile interface device detects an approach to a control target within a given distance, creates the remote control command for the control target, and sends the remote control command to an electronic control unit (ECU) installed in the control target through a radio frequency (RF) communication; a step of receiving operating status information in which the mobile interface device receives the operating status information about the control target depending on the remote control command from the ECU through the RF communication; and a step of sending the operating status information in which the mobile interface device sends the operating status information to a portable electronic apparatus through a short range wireless communication.

In the bidirectional remote control method, the step of sending the remote control command may include a step in which the mobile interface device receives a low frequency (LF) signal from the ECU and then calculates a distance between the mobile interface device and the control target; a step in which the mobile interface device creates the remote control command for the control target if the calculated distance is less than a given value; and a step in which the mobile interface device sends the remote control command to the ECU through the RF communication.

In the bidirectional remote control method, the step of sending the remote control command may include a step in which the mobile interface device receives the remote control command from the portable electronic apparatus through the short range wireless communication and then sends the received command to the ECU through the RF communication.

According to aspects of the present invention, a user can control the control target even though a user and the control target are separated in the far distance beyond a visible range. Also, a user can monitor the result of control, i.e., the operating status of the control target even in the far distance beyond a visible range. And also, it is possible to automatically control the control target by detecting a user's approach to the control target. Therefore, this invention may offer a great convenience to control the control target either at a short distance or at a long distance.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is a schematic view illustrating a remote control system using a mobile interface device in accordance with an exemplary embodiment of the present invention.

FIG. 2 is a block diagram illustrating the configuration of a portable electronic apparatus in accordance with an exemplary embodiment of the present invention.

FIG. 3 is a block diagram illustrating a mobile interface device in accordance with an exemplary embodiment of the present invention.

FIG. 4 is a block diagram illustrating an electronic control unit of a control target in accordance with an exemplary embodiment of the present invention.

FIG. 5 is a schematic view illustrating a case where a portable electronic apparatus is used as a power source of a mobile interface device in accordance with an exemplary embodiment of the present invention.

FIG. 6 is a flow diagram illustrating a method for reporting control results of a control target in accordance with an exemplary embodiment of the present invention.

FIG. 7 is a flow diagram illustrating a remote control method using a mobile interface device in accordance with an exemplary embodiment of the present invention.

FIG. 8 is a flow diagram illustrating a remote control method using a mobile interface device in accordance with another exemplary embodiment of the present invention.

### DETAILED DESCRIPTION OF THE INVENTION

Exemplary, non-limiting embodiments of the present invention will now be described more fully with reference to the accompanying drawings. This invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

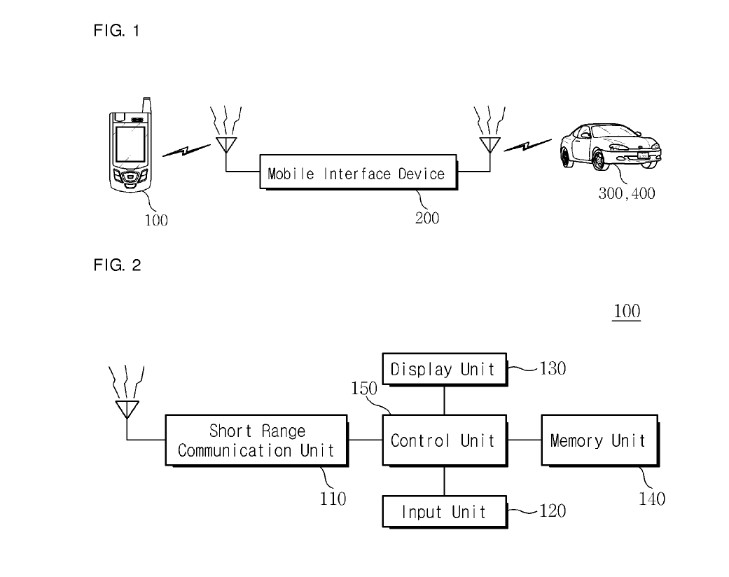

FIG. 1 is a schematic view illustrating a remote control system using a mobile interface device in accordance with an exemplary embodiment of the present invention.

Referring to FIG. 1, the remote control system is composed of a portable electronic apparatus 100, the mobile interface device 200, and an electronic control unit (ECU) 300 that is equipped in a control target 400.

The portable electronic apparatus 100 is a kind of equipment that is designed to have a short range communication unit based on one of short range wireless communication protocols and also to have a suitable application for controlling the control target 400 selected by a user. Also, the portable electronic apparatus 100 performs a short range communication with the mobile interface device 200. In this invention, the portable electronic apparatus 100 includes a mobile communication terminal (such as a cellular phone), a personal digital assistant (PDA), a portable multimedia player (PMP), a smart phone, a digital broadcast receiver based on DMB or DVB standard, and the like.

The mobile interface device 200 has a short range communication unit that uses the same short range wireless communication protocol as the portable electronic apparatus 100 uses, and thereby communicates with the portable electronic apparatus 100. Additionally, the mobile interface device 200 has a radio frequency (RF) transceiver unit used for an RF communication based on an RF communication protocol and thereby performs a communication with the ECU 300 in the control target 400. In this invention, the mobile interface device 200 is configured to be carried by a user having the portable electronic apparatus 100.

The ECU 300 is installed in the control target 400. Also, the ECU 300 has an RF transceiver unit that uses the same RF communication protocol as the mobile interface device 200 uses, thereby performing a communication with the mobile interface device 200. In this invention, the ECU 300 is configured to have a processor, to perform a communication with the mobile interface device 200, and to control the control target 400.

As shown, the control target 400 may be a car. This is, however, exemplary only and not to be considered as a limitation of this invention. Alternatively, the control target 400 may include a motorcycle, a computer, a digital door lock, a TV, a beam projector, and any other electronic devices that allow or need a user's remote control.

The above-mentioned short range wireless communication protocol is a wireless protocol having a transmission distance in a WPAN (wireless personal area network) range, in a WMAN (wireless metropolitan area network) range, or in a WLAN (wireless local area network) range. Normally the above-mentioned short range communication unit may be based on the Bluetooth standard. However, any other standard such as IrDA (infrared data association) or ZigBee may be alternatively used.

In embodiments of this invention, the RF communication protocol describes data transmission via RF waves having a broader transmission range in comparison with the short range wireless communication protocol. Herein, the RF communication protocol is defined as having a transmission range beyond a visible range in which a user can recognize the control target 400 with the naked eye. Namely, the RF communication protocol refers to a kind of wireless communication protocol that uses RF and has a greater transmission range than that of the short range wireless communication protocol.

Particularly, the portable electronic apparatus 100 creates a remote control command for controlling the control target 400 and then sends the created remote control command to the mobile interface device 200 through a short range wireless communication. In addition, the portable electronic apparatus 100 receives information about the status of the control target 400, operating in response to the remote control command, from the mobile interface device 200 and then displays on the screen the received information about operating status of the control target 400.

The mobile interface device 200 receives the remote control command from the portable electronic apparatus 100 through a short range wireless communication or creates the remote control command when detecting an approach to the control target 400 within a given distance. Then the mobile interface device 200 sends the remote control command to the ECU 300 in the control target 400 through the RF communication. Also, the mobile interface device 200 receives the operating status information about the control target 400 from the ECU 300 and then sends the received information to the portable electronic apparatus 100.

Namely, by using communications based on the short range wireless communication protocol and the RF communication protocol, the mobile interface device 200 performs a data relay between the portable electronic apparatus 100 and the ECU 300. Here, data may include a control command for the control target 400, status information about the control target 400, and the like.

In an embodiment of this invention, the mobile interface device 200 receives the remote control command for the control target 400 from the portable electronic apparatus 100 and then sends it to the ECU 300 so that the control target 400 can operate depending on the remote control command. Also, the mobile interface device 200 receives the operating status information about the control target 400 from the ECU 300 and then sends it to the portable electronic apparatus 100.

In another embodiment of this invention, the mobile interface device 200 detects its approach to the control target 400 within a given distance and creates the remote control command for the control target 400. Then the mobile interface device 200 sends the remote control command to the ECU 300 so that the control target 400 can operate depending on the remote control command.

The ECU 300 is installed in the control target 400 and receives the remote control command from the mobile interface device 200 through the RF communication. Then the ECU 300 enables the control target 400 to operate in response to the remote control command and also sends the operating status information about the control target 400 to the mobile interface device 200.

FIG. 2 is a block diagram illustrating the configuration of a portable electronic apparatus in accordance with an exemplary embodiment of the present invention.

Referring to FIGS. 1 and 2, the portable electronic apparatus 100 includes a short range communication unit 110, an input unit 120, a display unit 130, a memory unit 140 and a control unit 150.

The short range communication unit 110 is configured to perform a short range wireless communication of the portable electronic apparatus 100. Under the control of the control unit 150, the short range communication unit 110 transmits and receives data through a short range wireless communication channel that is established with the mobile interface device 200. Here, transmitted data may be a remote control command for the control target 400, and received data may be status information about the control target 400.

The short range communication unit 110 can perform a short range wireless communication with other short range communication device (i.e., with the mobile interface device 200) through a suitable antenna according to a short range wireless communication protocol. For this, the short range communication unit 110 searches for a host stack that administers a short range wireless communication, and also searches for an external short range communication device (i.e., the mobile interface device 200) as an object of communication. Additionally, the short range communication unit 110 stores a short range wireless communication profile, application, etc. that allow selecting a short range wireless connection according to search results. Therefore, the short range communication unit 110 may have or access a memory region.

The input unit 120 includes a plurality of input keys and function keys to receive a user's key manipulation and then to create a corresponding input signal. For instance, the input unit 120 has specific keys used to select a remote control command for the control target 400 and to execute transmission of the selected command. The input unit 120 sends such an input signal to the control unit 150.

The display unit 130 may display remotely controllable functions of the control target 400, so a user can select a desired one from the controllable functions displayed on the display unit 130. For instance, if the control target 400 is a car, the controllable function may relate to an open and shut of a door, a start-up of an engine, a lightening system, and the like. If the control target 400 is a TV, the controllable function may relate to power on/off, a channel selection, and the like. If the control target 400 is a beam projector, the controllable function may relate to power on/off, a display screen selection, and the like.

Additionally, the display unit 130 visually represents information about operating status of the control target 400. Specifically, the display unit 130 receives display data of the operating status information about the control target 400 from the control unit 150 and displays the received data thereon. For instance, if the control target is a car, the operating status information may indicate whether a door is opened or shut, whether an engine is started or not, whether a lightening system is turned on or off, and the like. If the control target 400 is a TV, the operating status information may indicate a power on or off, a selected channel, and the like. If the control target 400 is a beam projector, the operating status information may indicate a power on or off, a selected display screen, and the like.

Furthermore, the display unit 130 may visually offer a menu of the portable electronic apparatus 100, user's input data, function setting information, and any other information to a user. The display unit 130 may be formed of LCD (liquid crystal display) or any other equivalent. If LCD is in the form of touch screen, the display unit 130 may perform parts or all of functions of the input unit 120.

The memory unit 140 stores a variety of applications required for performing functions of the portable electronic apparatus 100 and also stores related data. The memory unit 140 may have at least one buffer that temporarily stores data produced while any application is running. The memory unit 140 may consist of a program region and a data region. The program region stores an operating system (OS) for booting the portable electronic apparatus 100, essential or optional applications of the portable electronic apparatus 100, and the like. The data region stores data produced while the portable electronic apparatus 100 is used. In particular, the data region may store data used for a remote control command for the control target 400, data used for a display of operating status information about the control target 400, and the like.

The control unit 150 may control the whole operation of the portable electronic apparatus 100 and signal flows between internal blocks of the portable electronic apparatus 100. Particularly, the control unit 150 detects a user's input for controlling a function of the control target 400 through the input unit 120, creates a remote control command for the control target 400 in response to the detected input, and sends the created command to the mobile interface device 200 through the short range communication unit 110. Also, the control unit 150 receives operating status information about the control target 400 from the mobile interface device 200 through the short range communication unit 110, produces display data for displaying the received information, and offers the produced data to the display unit 130.

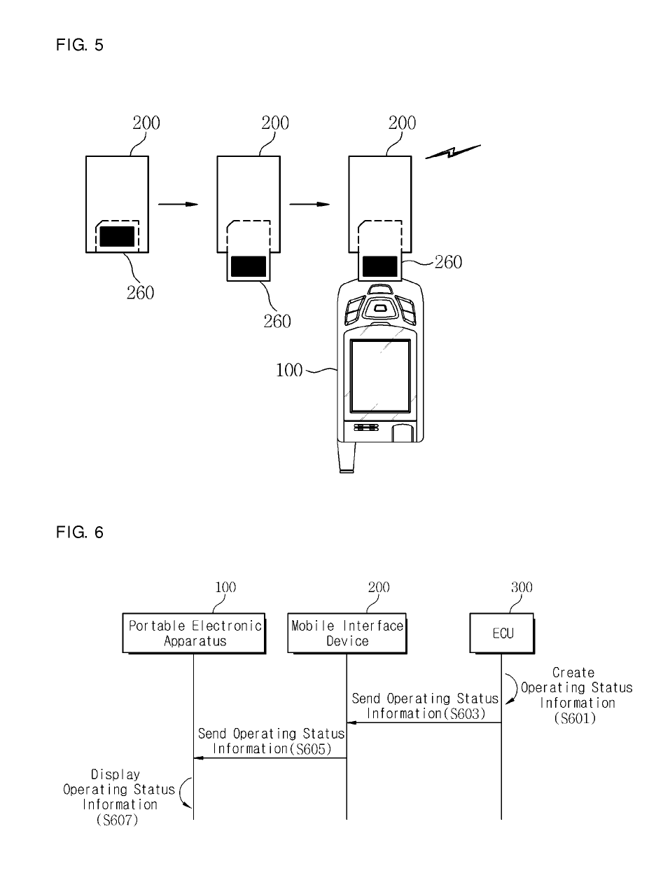

Although not illustrated, the portable electronic apparatus 100 may further have a storage insertion part into which an external storage medium such as a memory card is inserted. Also, the portable electronic apparatus 100 may have connection terminals used for data exchange, battery charging, etc. Particularly, the connection terminal of the portable electronic apparatus 100 may be configured to be connected with a connection unit (260 in FIG. 5) of the mobile interface device 200. Additionally, the portable electronic apparatus 100 may selectively include any other units such as a digital broadcast receiving module, a digital music play module (e.g. an MP3 module), and the like. According to a digital convergence tendency today, such units may be varied, modified and improved in various ways, and any other equivalents may be additionally or alternatively equipped in the portable electronic apparatus 100 as will be understood by those skilled in the art.

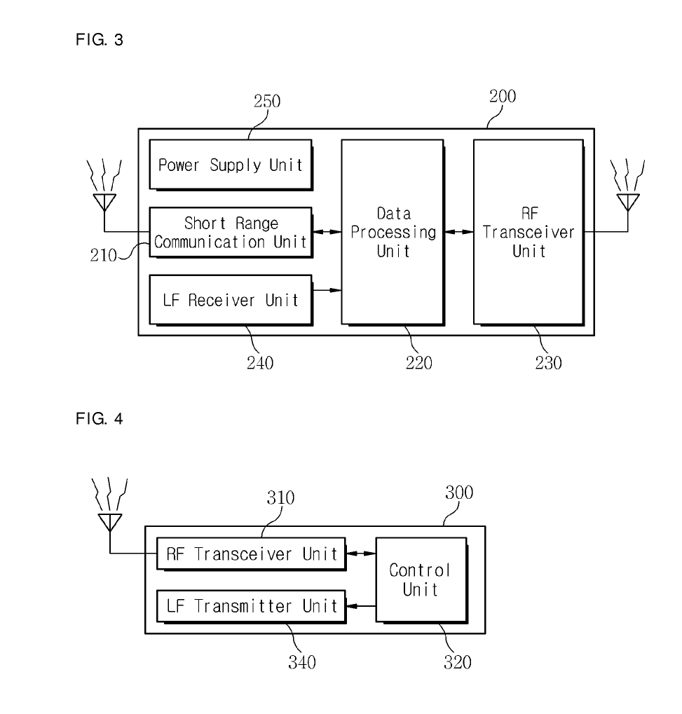

FIG. 3 is a block diagram illustrating a mobile interface device in accordance with an exemplary embodiment of the present invention.

Referring to FIGS. 1 to 3, the mobile interface device 200 includes a short range communication unit 210, a data processing unit 220, a radio frequency (RF) transceiver unit 230, a low frequency (LF) receiver unit 240, and a power supply unit 250.

The short range communication unit 210 can perform a short range wireless communication with other short range communication device (i.e., with the portable electronic apparatus 100) through a suitable antenna according to a short range wireless communication protocol. For this, the short range communication unit 210 searches for a host stack that administers a short range wireless communication, and also searches for an external short range communication device (i.e., the portable electronic apparatus 100) as an object of communication. Additionally, the short range communication unit 210 stores a short range wireless communication profile, application, etc. that allow selecting a short range wireless connection according to search results. Therefore, the short range communication unit 210 may have or access a memory region.

The data processing unit 220 and the RF transceiver unit 230 are used to perform a wireless data communication based on a wireless communication protocol through an antenna available for radio frequencies more than several hundred MHz.

The data processing unit 220 encodes or decodes and modulates or demodulates a remote control command and operating status information according to a communication type. For this, the data processing unit 220 may have a codec and a modem. The codec performs a coding of data to be transmitted and also performs a decoding of data received. The modem performs a modulation of a signal to be transmitted and also performs a demodulation of a modulated signal received through the RF transceiver unit 230.

The RF transceiver unit 230 receives data from the data processing unit 220 and then transmits it to the ECU 300 or receives data from the ECU 300. Here, the transmitted or received data includes a remote control command and operating status information. For RF communications, the RF transceiver unit 230 may have an RF transmitter that up-converts the frequency of a signal to be transmitted and amplifies the signal, and an RF receiver that performs a low noise amplifying (LNA) of a received signal and down-converts the frequency of the signal.

The LF receiver unit 240 receives an LF signal from an antenna, being available for low frequencies less than several ten KHz, of the control target 400 and then sends it to the data processing unit 220. When receiving an LF signal from the ECU 300 through the LF receiver unit 240, the data processing unit 220 calculates a distance between the control target 400 and a user having the mobile interface device 200. If the calculated distance is less than a given value, the data processing unit 220 creates a predefined remote control command for the control target 400 and then sends it to the ECU 300 through the RF transceiver unit 230. Namely, when a user approaches the control target 400 within a given distance, it is supposed that a user desires the control target 400 to operate.

The power supply unit 250 receives electric power from the portable electronic apparatus 100 when directly connected with the portable electronic apparatus 100. For this, the mobile interface device 200 may further have a connection unit (260 in FIG. 5) that can be coupled to the connection terminal of the portable electronic apparatus 100.

FIG. 4 is a block diagram illustrating an electronic control unit (ECU) of a control target in accordance with an exemplary embodiment of the present invention.

Referring to FIGS. 1 to 4, the ECU 300 is installed in the control target 400 and includes an RF transceiver unit 310, a control unit 320 and an LF transmitter unit 340.

The RF transceiver unit 310 is used to perform a wireless data communication through an antenna available for radio frequencies more than several hundred MHz. The RF transceiver 310 performs an RF wireless communication with the mobile interface device 200 according to an RF communication protocol. The RF transceiver 310 receives a remote control signal from the mobile interface device 200 and also sends operating status information to the mobile interface device 200. For this, the RF transceiver unit 310 may have a codec for a coding or decoding of data, a modem for a modulation or demodulation of data, an RF transmitter for sending data after up-converting the frequency of data, an RF receiver for down-converting the frequency of received data, and a converter for converting data into analog or digital data.

The LF transmitter unit 340 sends an LF signal through an antenna available for low frequencies less than several ten KHz. The mobile interface device 200 receives an LF signal from the LF transmitter 340 through the LF receiver 240 and then, by using the received LF signal, calculates a distance between the control target 400 and a user.

The control unit 320 receives a remote control command from the mobile interface device 200 through the RF transceiver unit 310 and then outputs a control signal for operation of the control target 400 in response to the received command. Also, the control unit 320 receives operating status of the control target 400 that operates depending on the control signal and then creates operating status information for each control. And also, the control unit 320 sends the created information to the mobile interface device 200 through the RF transceiver 310.

FIG. 5 is a schematic view illustrating a case where a portable electronic apparatus is used as a power source of a mobile interface device in accordance with an exemplary embodiment of the present invention.

Referring to FIG. 5, the mobile interface device 200 has a connection unit 260 in order to use a power source of the portable electronic apparatus 100. The connection unit 260 is designed to be coupled to the connection terminal of the portable electronic apparatus 100.

When the connection unit 260 of the mobile interface device 200 is coupled to the connection terminal of the portable electronic apparatus 100 as shown, electric power of the portable electronic apparatus 100 can be supplied to the mobile interface device 200. This supply of electric power may be automatically made or in response to a user's input signal from the input unit of the portable electronic apparatus 100.

FIG. 6 is a flow diagram illustrating a method for reporting control results of a control target in accordance with an exemplary embodiment of the present invention.

Referring to FIGS. 1 to 4 and 6, the ECU 300 in the control target 400 continuously creates the operating status information in response to various control signals (step S601). In this step, the ECU 300 may receive the remote control command from the portable electronic apparatus 100 and then create the operating status information as the result of processing. Alternatively, the ECU 300 may monitor the status of the control target 400 on its own and thereby create the operating status information.

Next, the ECU 300 sends the operating status information to the mobile interface device 200 through an RF communication (step S603). Therefore, the mobile interface device 200 receives the operating status information about the control target 400 through an RF communication.

Then the mobile interface device 200 sends the received information to the portable electronic apparatus 100 through a short range wireless communication (step S605).

When receiving the operating status information, the portable electronic apparatus 100 displays the operating status information about the control target 400 on the screen of the display unit 130 (step S607). In this step, the portable electronic apparatus 100 produces display data for displaying the received information and then offers the produced data to the display unit 130. A user can check the operating status of the control target 400 through the displayed information and then, depending on the checked status, take a follow-up action for a remote control of the control target 400.

For instance, in case where the control target 400 is a car, it may happen that a user leaves the car without turning off the light. If a user desires to turn off the light, he or she has to go back to the car. In order to solve this inconvenient problem, this invention provides a solution by which the operating status information about the car is offered to the portable electronic apparatus 100 and hence, even in the far distance, a user can control the car through the portable electronic apparatus 100 or the mobile interface device 200.

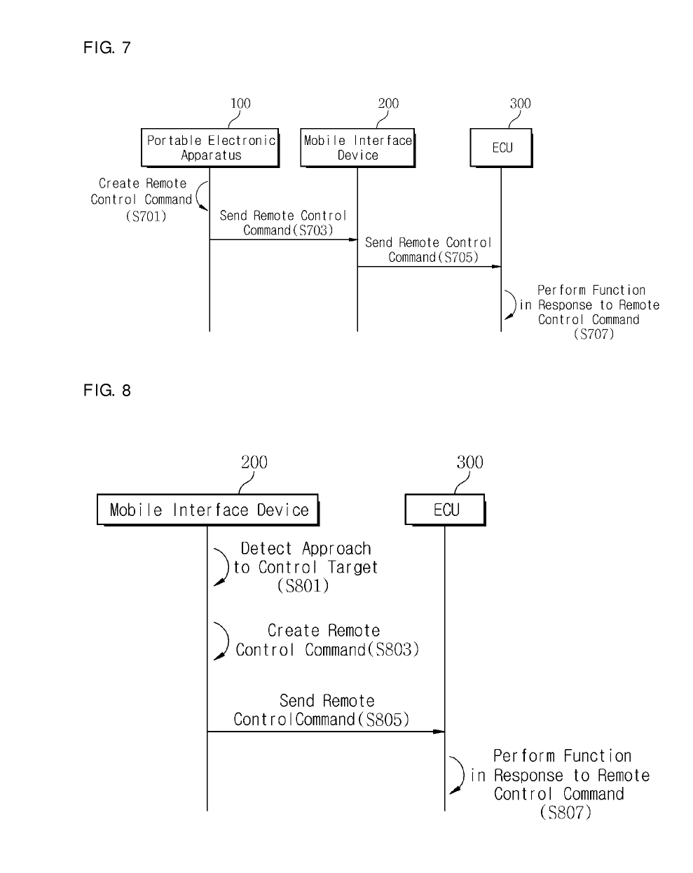

FIG. 7 is a flow diagram illustrating a remote control method using a mobile interface device in accordance with an exemplary embodiment of the present invention.

Referring to FIGS. 1 to 4 and 7, the portable electronic apparatus 100 creates a control command for the control target 400 (step S701). Specifically, the portable electronic apparatus 100 may display controllable functions of the control target 400 according to the operating status of the control target 400 and then, depending on a user's selection, create the remote control command for the control target 400.

Additionally, as discussed in FIG. 6, the portable electronic apparatus 100 may display the operating status information about the control target 400. Then the portable electronic apparatus 100 may receive a user's input for controlling a function of the control target 400 and hence, depending on a user's input, create the remote control command for the control target 400.

Next, the portable electronic apparatus 100 sends the remote control command for the control target 400 to the mobile interface device 200 through a short range wireless communication (step S703).

Here, the mobile interface device 200 receives an identification number for a short range wireless communication from the portable electronic apparatus 100. Then the received number is compared with an identification number stored in the mobile interface device 200. If both numbers are identical, the mobile interface device 200 receives the remote control command for the control target 400 from the portable electronic apparatus 100.

Next, the mobile interface device 200 sends the remote control command for the control target 400 to the ECU 300 of the control target 400 through an RF communication (step S705).

The ECU 300 receives the remote control command for the control target 400 through an RF communication and then performs a particular function in response to the received command (step S707).

Thereafter, as discussed in FIG. 6, the ECU 300 of the control target 400 may send the operating status information about the control target 400 to the portable electronic apparatus 100 through the mobile interface device 200. Then a user can check the operating status of the control target 400 through the portable electronic apparatus 100.

FIG. 8 is a flow diagram illustrating a remote control method using a mobile interface device in accordance with another exemplary embodiment of the present invention.

Referring to FIGS. 1 to 4 and 8, when a user approaches the control target 400 within a given distance, the mobile interface device 200 detects it through an LF antenna of the LF receiver unit 240 (step S801). Specifically, the LF receiver unit 240 detects an LF signal sent from an LF antenna of the LF transmitter unit 340 in the control target 400 and thereby can find a distance between a user and the control target 400. Namely, the mobile interface device 200 receives an LF signal of the ECU through the LF receiver unit 240 and then calculates a distance between the control target 400 and a user having the mobile interface device 200.

Next, the mobile interface device 200 creates a predefined remote control command for the control target 400 (step S803). Specifically, depending on the calculated distance between the control target 400 and a user, the data processing unit 220 of the mobile interface device 200 creates the remote control command for the control target 400. For instance, if the calculated distance is less than a given value, the control target 400 is set to operate. Therefore, when a user having the mobile interface device 200 approaches the control target 400 within a given distance, the mobile interface device 200 creates the remote control command to control the control target 400.

Next, the mobile interface device 200 sends the remote control command for the control target 400 to the ECU 300 through an RF communication (step S805).

Then the ECU 300 receives the remote control command for the control target 400 through an RF communication and then performs a particular function in response to the received command (step S807).

Thereafter, as discussed in FIG. 6, the ECU 300 may send the operating status information about the control target 400 to the portable electronic apparatus 100 through the mobile interface device 200. Then a user can check the operating status of the control target 400 through the portable electronic apparatus 100.

As fully discussed hereinbefore, according to embodiments of this invention, a user can control the control target 400 through the portable electronic apparatus 100 and the mobile interface device 200 even though a user and the control target are separated in the far distance beyond a visible range. Also, since the portable electronic apparatus 100 receives the operating status information about the control target 400 from the ECU 300, a user can easily monitor the operating status of the control target 400 through the portable electronic apparatus 100 and then easily take a follow-up action for a remote control of the control target 400.

While this invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. A remote control system for a selected control target, the system comprising:
a portable electronic apparatus configured to create a remote control command for controlling the control target, to send the created command to a mobile interface device through a short range wireless communication, to receive operating status information about the control target depending on the remote control command from the mobile interface device, and to display the received information thereon;
the mobile interface device configured to receive the remote control command from the portable electronic apparatus through the short range wireless communication or to create the remote control command when detecting an approach to the control target within a given distance, to send the remote control command to an electronic control unit (ECU) in the control target through a radio frequency (RF) communication, to receive the operating status information about the control target from the ECU, and to send the received information to the portable electronic apparatus; and
the ECU installed in the control target and also configured to receive the remote control command from the mobile interface device through the RF communication, to enable the control target to operate in response to the received command, and to send the operating status information about the control target to the mobile interface device.

2. The system of claim 1, wherein the portable electronic apparatus includes:
an input unit configured to receive a user's manipulation and then to create a corresponding input signal;
a short range communication unit configured to perform the short range wireless communication with the mobile interface device; and
a control unit configured to create the remote control command for the control target in response to the input signal from the input unit and then to send the created command to the mobile interface device through the short range communication unit.

3. The system of claim 2, wherein the portable electronic apparatus further includes:
a display unit configured to display the operating status information under the control of the control unit.

4. The system of claim 1, wherein the ECU includes:
an RF transceiver unit configured to perform the RF communication with the mobile interface device; and
a control unit configured to receive the remote control command from the mobile interface device through the RF transceiver unit, to output a control signal for operation of the control target in response to the received command, and to send the operating status information about the control target to the mobile interface device through the RF transceiver.

5. The system of claim 4, wherein the ECU further includes:
a low frequency (LF) transmitter unit configured to send an LF signal, and
wherein the mobile interface device is further configured to receive the LF signal from the LF transmitter of the ECU, to determine by using the received LF signal whether the mobile interface device approaches the control target, to create the remote control command for the control target in case of an approach to the control target, and to send the created command to the ECU through the RF communication.

6. The system of claim 1, wherein the control target includes at least one of a car, a motorcycle, a computer, a digital door lock, a TV, and a beam projector.

7. A mobile interface device comprising:
a short range communication unit configured to perform a short range wireless communication with a portable electronic apparatus;
a radio frequency (RF) transceiver unit configured to perform an RF communication with an electronic control unit (ECU) installed in a control target; and
a data processing unit configured to create a remote control command for the control target by detecting an approach to the control target within a given distance, to send the remote control command to the ECU through the RF transceiver unit, to receive operating status information about the control target depending on the remote control command from the ECU through the RF transceiver unit, and to send the received information to the portable electronic apparatus through the short range communication unit.

8. The device of claim 7, further comprising:
a low frequency (LF) receiver unit configured to receive an LF signal from the ECU,
wherein the data processing unit is further configured to receive the LF signal from the ECU through the LF receiver unit, to calculate a distance between the mobile interface device and the control target, to create the predefined remote control command for the control target if the calculated distance is less than a given value, and to send the created command to the ECU through the RF transceiver unit.

9. The device of claim 7, wherein the data processing unit is further configured to receive the remote control command for the control target from the portable electronic apparatus through the short range communication unit and then to send the received command to the ECU through the RF transceiver unit.

10. The device of claim 7, further comprising:
a connection unit configured to be coupled to a connection terminal of the portable electronic apparatus.

11. The device of claim 10, wherein the connection unit receives electric power from the portable electronic apparatus after being coupled to the connection terminal of the portable electronic apparatus.

12. A bidirectional remote control method using a mobile interface device, the method comprising:
a step of sending a remote control command in which a mobile interface device detects an approach to a control target within a given distance, creates the remote control command for the control target, and sends the remote control command to an electronic control unit (ECU) installed in the control target through a radio frequency (RF) communication;
a step of receiving operating status information in which the mobile interface device receives the operating status information about the control target depending on the remote control command from the ECU through the RF communication; and
a step of sending the operating status information in which the mobile interface device sends the operating status information to a portable electronic apparatus through a short range wireless communication.

13. The method of claim 12, wherein the step of sending the remote control command includes:
a step in which the mobile interface device receives a low frequency (LF) signal from the ECU and then calculates a distance between the mobile interface device and the control target;
a step in which the mobile interface device creates the remote control command for the control target if the calculated distance is less than a given value; and
a step in which the mobile interface device sends the remote control command to the ECU through the RF communication.

14. The method of claim 12, wherein the step of sending the remote control command includes:
a step in which the mobile interface device receives the remote control command from the portable electronic apparatus through the short range wireless communication and then sends the received command to the ECU through the RF communication.
